(19) United States
(12) Patent Application Publication
(10) Pub. No.: US 2017/0201493 A1
(43) Pub. Date: Jul. 13, 2017

(54) SYSTEM AND METHOD FOR SECURE AND ANONYMOUS COMMUNICATION IN A NETWORK

(71) Applicant: Qabel GmbH, Hannover (DE)

(72) Inventor: Christian W. Zuckschwerdt, Oldenburg (DE)

(21) Appl. No.: 15/314,374

(22) PCT Filed: May 27, 2015
(86) PCT No.: PCT/EP2015/001089

§ 371 Date: Nov. 28, 2016

(30) Foreign Application Priority Data
May 28, 2014 (DE) 10 2014 008 059.5

(51) Int. Cl. H04L 29/06

(52) U.S. Cl. CPC H04L 63/0414; H04L 63/0428

(57) ABSTRACT

The present disclosure provides a computer system, a computer-implemented method and a computer program product for the secure and anonymous interchange of messages via a network. At least one encrypted message from at least one transmitter is received on at least one message server via the network. The message server makes the at least one encrypted message available to at least one receiver for retrieval via the network. Data about the at least one transmitter and the at least one receiver of the at least one encrypted message are encrypted.

### CROSS REFERENCE TO RELATED APPLICATIONS

This application is a National Stage Entry of PCT/EP2015/001089 filed May 27, 2015, which claims priority to DE Patent Application No. 10 2014 008 059.5 filed May 28, 2014, both of which are incorporated herein in their entirety.

### BACKGROUND

The present invention relates to a computer system, a computer-implemented method, and a computer program product for the secure and anonymous exchange of data over a network.

Networks, in particular the Internet, allow their users to exchange data (e.g. messages) with other users anytime and anywhere over the Internet by means of (mobile) terminal devices. At the same time, the need for a secure and anonymous data transmission over the Internet increases due to the rapid development of possibilities to store and analyze data. Therefore, it is desirable to provide electronic communication systems that are adapted to protect data (especially news) electronically sent over a network against unauthorized reading, against spying of so-called metadata of this data, as well as against any manipulation of data by unauthorized third parties.

A network is either a wired network or a wireless network, e.g. a radio network, which is composed of different, primarily independent technical or electronic systems and allows individual devices to communicate with each other, such as the Internet or an intranet. A network may be composed of a plurality of differently adapted subnetworks, which are connected to each other via different communication protocols.

A terminal device is a device that is capable of communicating with each other over wired networks, e.g. Ethernet or token ring.

A mobile device is a device that is capable of communicating wirelessly in a mobile network over Local Area Networks (LANs), such as Wireless Fidelity (WiFi), or over Wide Area Networks (WANs), such as Global System for Mobile Communication (GSM), General Package Radio Service (GPRS), Enhanced Data Rates for Global Evolution (EDGE), Universal Mobile Telecommunications System (UMTS), High-speed Downlink/Uplink Packet Access (HSDPA, HSDPA), Long-Term Evolution (LTE), or World Wide Interoperability for Microwave Access (WIMAX). Communication via further current or future communication technologies is possible. The term mobile terminal device includes in particular smartphones, but also other mobile phones or cell phones, personal digital assistants (PDAs), tablet PCs, as well as all other suitable electronic devices equipped with appropriate technologies to communicate over a network.

Known systems for data and message transmission over a (wireless or wired) network require direct addressing of the messages. Also an encrypted message exchange, for example, through the Hypertext Transfer Protocol Secure (HTTPS), requires authentication of the communication partners (i.e. transmitter and receiver), as this ensures that every communication partner can ensure themselves of the identity of the respective other communication partner prior to the establishment of a secure, encrypted communication over a network. A data and message transmission e.g. through the Extensible Messaging and Presence Protocol (XMPP) is very comprehensive and complex, as a plurality of extensions and methods for message transmission is provided. Thereby, the server gains insights into the data and message exchange between transmitters and receivers (i.e. communication partners), as well as into inventory data of the respective communication partners. This allows an analysis of the corresponding data and message traffic by the server and by a third party.

### BRIEF DESCRIPTION

The present disclosure provides an anonymous, encrypted communication (for example an anonymous, encrypted message exchange) over a network in a simple, cost-efficient and secure way. In particular, one or more of the following aspects for secure communication over a network are to be ensured:
Confidentiality: Only authorized receivers shall be able to read and/or modify data when accessing stored data and also during or after data transmission;
Integrity: Falsification of data by unauthorized third parties must be prevented;
Anonymity: No third party shall know between which parties a data exchange took place.

According to a first aspect, a computer system for the secure and anonymous exchange of messages is provided. The system includes at least one message server, which is adapted to receive at least one encrypted message from at least one transmitter over the network and to store the at least one encrypted message at least temporarily. Moreover, the at least one message server is adapted to provide the at least one encrypted message to at least one receiver for retrieval over the network. Here, data of the at least one transmitter and of the at least one receiver of the at least one encrypted message is encrypted.

A message server may be a server that is adapted to buffer incoming messages for later retrieval by a receiver. The message server can be addressed via an identification, ID (as explained further below with respect to the addressing of the message servers). In other words, the message server may be a hardware server on which software is installed, with a corresponding functionality, i.e. at least partial storage of at least one encrypted message coming in over a network and provision of the at least one encrypted message for retrieval over the network to a receiver. The hardware message server may be a simple Representational State Transfer (REST)-compliant server. Other than with web services-oriented protocols (e.g. Simple Object Access Protocol, SOAP), no functions such as Remote Procedure Calls (RPC) are carried out on a REST-compliant server. Instead, any data and message exchange with the server leads to a storage, modification, or creation of a document. This has the advantage that a third party cannot draw conclusions as to operational structures of the server and intentions of the transmitter.

However, the message server may also be a software server, which as a software program, according to a client-server-model, provides a functionality, i.e. at least partial storage of at least one encrypted message coming in over a network and provision of the at least one encrypted message for retrieval over the network to a receiver. In this case, a plurality of so-called message servers can be implemented on a hardware server, each of which being addressable via an identification, ID (as explained further below with respect to the addressing of the message servers).

The encrypted messages may be buffered in a message buffer on the message server, the message buffer being limited in its length and its storage capacity. The encrypted messages may be buffered in a First In First Out (FIFO) queue, which serves as a message buffer.

This has the advantage that no direct data exchange has to take place between transmitter and receiver. Thus, there is no need for the transmitter and the receiver to have any further knowledge of each other, i.e. of actual identities, Internet Protocol (IP) addresses or of an availability of the respective transmitter and receiver involved in the communication.

In contrast, known systems require the respective IP addresses of transmitter and receiver for an exchange of messages. By knowing the IP addresses, one can draw conclusions on further details of a message exchange, e.g. availability of transmitter and receiver, response time (latency), and identification of the type of computer system used, e.g. of the operating system.

The buffered, encrypted messages that are on the message server cannot be modified, deleted or removed neither by the transmitter and the receiver nor by a third party. However, the messages may receive a so-called time stamp when they arrive on the message server. Thus, messages coming in on the message server may expire after expiry of a predetermined time period, i.e. be deleted by the message server automatically. In addition or alternatively, the messages may be deleted from the message server depending on storage space available to the message server. In addition or alternatively, the messages may be deleted from the message server depending on other suitable parameters.

Encryption of data of the at least one transmitter and the at least one receiver of the at least one encrypted message has the advantage that no third party having authorized or unauthorized access to the encrypted message, in particular the message server itself, can draw conclusions on the transmitter and the receiver of the message exchange. Therefore, anonymous communication between transmitter and receiver via the message server is ensured.

The data of the at least one transmitter and the at least one receiver of the at least one encrypted message may include one or more of the following data:
A transmitter address of the at least one transmitter;
A receiver address of the at least one receiver;
An encryption method used to encrypt the at least one encrypted message;
Encryption parameters used to encrypt the at least one encrypted message.

Arrangements to encrypt the message, i.e. to agree on an encryption method to be used and on correspondingly required encryption parameters, may be made by the at least one transmitter and the at least one receiver. The transmitter and receiver negotiate details about the encryption via an external server, i.e. outside the secure and anonymous exchange of messages through the computer system (out-of-band). Here, the transmitter and the receiver may agree on any known and appropriate, symmetrical encryption method, such as Advanced Encryption Standard (AES), Data Encryption Standard (DES), Triple-DES, International Data Encryption Algorithm (IDEA), or any known and appropriate, asymmetrical encryption method, such as Rivest, Shamir, and Adleman (RSA). This has the advantage that the message server does not have knowledge of the encryption details of the encrypted message, but is only able to store the encrypted message. Therefore, neither the message server nor a third party can draw conclusions on encryption details of the encrypted message.

The data of the at least one transmitter and the at least one receiver of the at least one encrypted message include metadata of the transmitter, and correspondingly of the receiver. In particular, this data includes: a transmitter address of the at least one transmitter, a receiver address of the at least one receiver, an encryption method used to encrypt the at least one encrypted message, and/or encryption parameters used to encrypt the at least one encrypted message.

This has the advantage that neither the message server nor a third party can draw conclusions as to which data of the transmitter and the receiver has been encrypted together with the message by the transmitter. Moreover, the message server only uses a time of arrival of the message as metadata. The message server may create a so-called timestamp of the reception time of the encrypted message and stores it together with the message in the FIFO queue. Further metadata possibly arising in connection with the reception of the encrypted message by the message server, e.g. the IP address of the transmitter, HTTP headers used and a timing, may be immediately discarded by the message server.

The encryption of the data has the advantage that no third party, especially not the message server itself, can make any assumptions as to the structure and/or the content of the at least one encrypted message.

The data of the at least one transmitter and the at least one receiver may be encrypted together with the at least one encrypted message.

Thus, the data of the at least one transmitter and the at least one receiver, together with the at least one encrypted message, is completely unstructured. This has the advantage that the data of the transmitter and the receiver can only be reconstructed knowing the encryption parameters. The transmitter encrypts the message and the data of the transmitter and the receiver before sending the thus-encrypted message to the message server.

Optionally, the at least one transmitter and the at least one receiver may agree on which data of the transmitter and the receiver is to be encrypted together with the message via the external server, together with the agreement on the encryption details. Alternatively, the transmitter may inform the receiver out-of-band about which data of the transmitter and the receiver has been encrypted together with the message after the encrypted message has been sent.

This approach has the advantage that encrypted messages can be exchanged over existing protocols. It is only required, in addition to an ordinary message exchange, to encrypt the corresponding data of the transmitter and of the receiver along with the message itself. Sending, receiving, and retrieving the encrypted message may take place via the Hypertext Transfer Protocol (HTTP), wherein standard Internet Assigned Numbers Authority (IANA) port numbers may be used. The only non-encrypted data in the encrypted message is therefore data or metadata of the HTTP communication itself. Optionally, the HTTP communication may be secured by Transport Layer Security (TLS) encryption (HTTPS).

Thus, encrypted messages can be exchanged securely and anonymously over the network, without being distinguishable from ordinary messages from outside. Only by using Deep Packet Inspection (DPI), in which both the metadata in the header of a data packet and the user data is checked for specific features, is it possible to determine that the encrypted messages are not messages. But even DPI does not allow analyses of the contents of the encrypted messages.

The at least one transmitter and the at least one receiver may agree on an address of the at least one message server at a time prior to reception of the at least one message by the at least one message server.

The agreement on the address of the at least one message server may be reached outside the main form of communication through the message server, out-of-band. Here, the at least one message server may be addressed via an ID (as explained further below with respect to the addressing of the message servers). Optionally, the transmitter my send the encrypted message to any message server. The transmitter may communicate the ID of the selected message server out-of-band in this case.

The at least one message server may store a reception time stamp of the encrypted message on the at least one message server when the at least one encrypted message is received and stored.

The at least one message server may delete the received message after a predetermined or predeterminable period of time as of the reception time stamp.

This has the advantage that the message server can use the reception time stamp as a key to retrieve new messages. In this way, the message server can send all messages received after a time of last retrieval of encrypted messages by the receiver on the message server to the receiver.

According to a further aspect, a computer-implemented method for a secure and anonymous exchange of messages over a network is provided. The method includes receiving, by the at least one message server, at least one encrypted message from at least one transmitter over the network, the at least one message server being adapted to store the received at least one encrypted message at least temporarily. The at least one message server provides the at least one encrypted message for retrieval by the at least one receiver over the network. Data of the at least one transmitter and of the at least one receiver of the at least one encrypted message is encrypted

The data of the at least one transmitter and the at least one receiver of the at least one encrypted message may include one or more of the following data:
A transmitter address of the at least one transmitter;
A receiver address of the at least one receiver;
An encryption method used to encrypt the at least one encrypted message;
Encryption parameters used to encrypt the at least one encrypted message.

The data of the at least one transmitter and the at least one receiver may be encrypted together with the at least one encrypted message.

The at least one transmitter and the at least one receiver may agree on an address of the at least one message server at a time prior to reception of the at least one message by the at least one message server.

The at least one message server may store a reception time stamp of the encrypted message on the at least one message server when the at least one encrypted message is received and stored.

The at least one message server may delete the received message after a predetermined or predeterminable period of time as of the reception time stamp.

According to a further aspect, a computer program product including program parts that, when loaded in a computer, are adapted to perform a computer-implemented method for a secure and anonymous exchange of messages over a network is provided. The method includes receiving, by the at least one message server, at least one encrypted message from at least one transmitter over the network, the at least one message server being adapted to store the received at least one encrypted message at least temporarily. The at least one message server provides the at least one encrypted message for retrieval by the at least one receiver over the network. Data of the at least one transmitter and of the at least one receiver of the at least one encrypted message is encrypted.

The data of the at least one transmitter and the at least one receiver of the at least one encrypted message may include one or more of the following data:
A transmitter address of the at least one transmitter;
A receiver address of the at least one receiver;
An encryption method used to encrypt the at least one encrypted message;
Encryption parameters used to encrypt the at least one encrypted message.

The data of the at least one transmitter and the at least one receiver may be encrypted together with the at least one encrypted message.

The at least one transmitter and the at least one receiver may agree on an address of the at least one message server at a time prior to reception of the at least one message by the at least one message server.

The at least one message server may store a reception time stamp of the encrypted message on the at least one message server when the at least one encrypted message is received and stored.

The at least one message server may delete the received message after a predetermined or predeterminable period of time as of the reception time stamp.

### BRIEF DESCRIPTION OF THE DRAWINGS

Example embodiments will be described exemplarily in the following with reference to accompanying drawings. It should be noted that even if embodiments are described separately, individual features thereof can be combined to form additional embodiments. The figures show:

FIG. 1 illustrates a transmitter and a receiver that can exchange messages anonymously and securely over a message server;

FIG. 2 illustrates a method with which a transmitter and a receiver can exchange messages anonymously and securely over a message server;

FIG. 3 illustrates an example system for implementing the embodiments of the disclosure.

### DETAILED DESCRIPTION

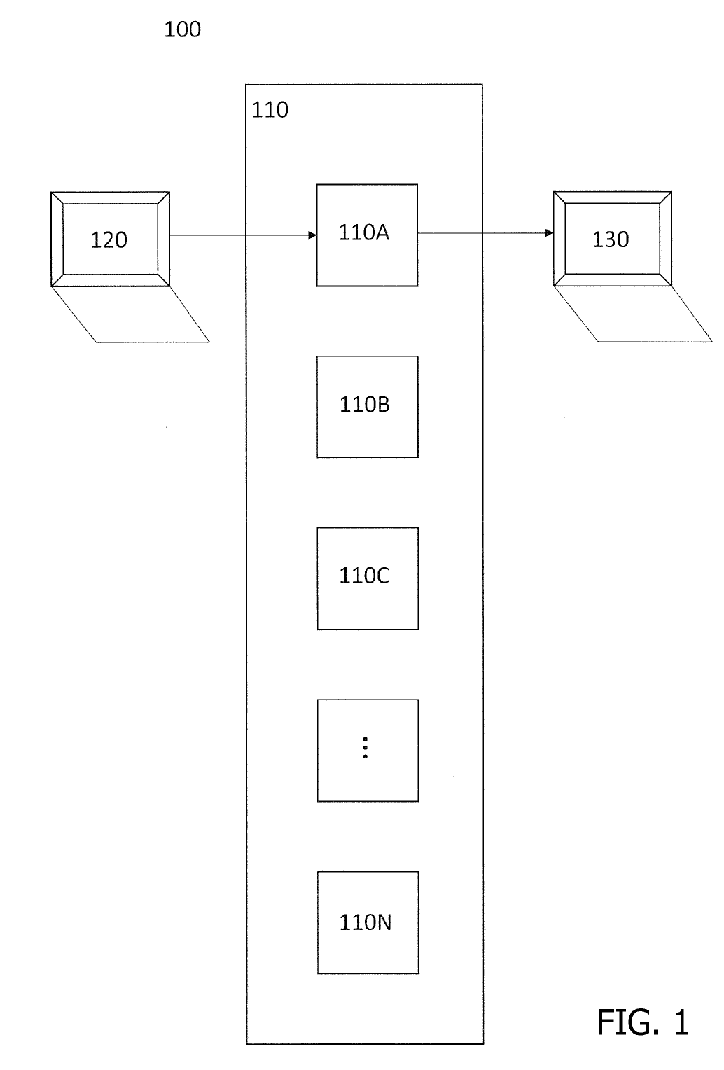

FIG. 1 shows a system including a server. N message servers may be implemented on the server. A message server is a server that is capable of storing and buffering incoming encrypted messages for later retrieval by a receiver at least temporarily. The message server can be addressed via an identification, ID (as explained further below with respect to the addressing of the message servers).

A message server may be a hardware server (not shown in FIG. 1), on which software is installed, which provides a corresponding functionality for the at least partial storage of incoming encrypted messages and provision of a retrieval possibility of encrypted messages by receivers. The hardware message server may be a simple Representational State Transfer (REST)-compliant server, in which any data and message exchange with the server leads to a loading, modification, or creation of a document. This has the advantage that a third party cannot draw conclusions as to operational structures of the server and intentions of the transmitter. The message server may run independently, for example behind a reverse proxy. Alternatively, the message server may run in an existing HTTP environment, e.g. PHP or Ruby on Rails.

Alternatively, the message server may also be a software server, which as a software program, according to a client-server-model, provides the functionality for the at least partial storage of incoming encrypted messages and provision of a retrieval possibility of encrypted messages by receivers. In this case, a plurality of message servers can be implemented on a hardware server or another suitable computer system, each of which being addressable via their own identification, ID (as explained further below with respect to the addressing of the message servers).

One or more transmitters can send encrypted messages to one or more message servers. Those methods (as explained further below with reference to the Representational State Transfer (REST) methods) are available to the transmitter for sending encrypted messages to a message server. However, other suitable methods of sending the encrypted messages from the message server are conceivable as well.

The encrypted messages are stored and buffered in a message buffer on the message server at least temporarily, wherein the message buffer may be limited in its length and its storage capacity. The encrypted messages may be buffered in a First In First Out (FIFO) queue, which serves as a message buffer.

The buffered, encrypted messages that are on the message server cannot be modified or deleted neither by the transmitter and the receiver nor by a third party. Thus, no party is allowed to falsify or delete the encrypted messages received on the message server.

The encrypted messages coming in on the message server may be provided with a time stamp. Accordingly, messages may expire after expiry of a predetermined time period or course of time, i.e. be deleted or removed from the FIFO queue by the message server itself. In addition or alternatively, the messages may be deleted from the message server depending on storage space available to the message server. In addition or alternatively, the messages may be deleted from the message server depending on other suitable parameters.

The encrypted messages including encrypted data of the at least one transmitter and receiver has the advantage that no third party having authorized or unauthorized access to the encrypted data, can draw conclusions on the communication parties, i.e. transmitter and receiver, of the message exchange. Therefore, anonymous communication between transmitter and receiver is ensured, and the actual communication between transmitter and receiver cannot be retraced. Also, the encryption of data of the transmitter and the receiver has the advantage that the message server itself cannot make assumptions as to the structure and the contents of the encrypted messages.

The at least one transmitter and the at least one receiver exchanging messages over at least one message server may have agreed on an encryption method in advance, i.e. prior to the actual message exchange.

Here, the transmitter-receiver pair may agree on any known and appropriate, symmetrical encryption method, such as Advanced Encryption Standard (AES), Data Encryption Etandard (DES), Triple-DES, International Data Encryption Algorithm (IDEA), or any known and appropriate, asymmetrical encryption method, such as Rivest, Shamir, and Adleman (RSA).

The communication parties may agree on the encryption method outside the main form of communication through the computer system or message server, out-of-band.

This has the advantage that for a secure and anonymous exchange of encrypted messages over the system between the at least one transmitter and the at least one receiver, no direct data exchange must take place Thus, there is no need for the communication parties to have any further knowledge of each other, i.e. of actual identities, Internet Protocol (IP) addresses or of a respective availability.

The communication parties, i.e. at least one transmitter and at least one receiver, may exchanging encrypted messages over the computer system agree out-of-band in advance on an address of a message server residing on the computer system, via which at least one encrypted message is to be exchanged. Each message server can be addressed via an ID (as explained further below with respect to the addressing of the message servers). Optionally, the transmitter can send the encrypted message to an arbitrary message server. In this case, the transmitter may communicate the ID of the selected message server out-of-band to the receiver.

The data of transmitter and receiver, communication parties, may be encrypted along with the message. Encryption of the data of the transmitter and the receiver has the advantage that thus-encrypted messages can be send over existing protocols. At the same time, no third party has the opportunity to obtain information about the transmitter and the receiver of a message, so that anonymity of the communication parties is ensured.

The data of the at least one transmitter and the at least one receiver of the at least one encrypted message include metadata of the transmitter, and correspondingly of the receiver. In particular, this data includes: a transmitter address of the at least one transmitter, a receiver address of the at least one receiver, an encryption method used to encrypt the at least one encrypted message, and/or encryption parameters used to encrypt the at least one encrypted message.

This has the advantage that neither the message server nor a third party can draw conclusions as to which data of the transmitter and the receiver has been encrypted together with the message by the transmitter. Moreover, the message server only knows a time of arrival of the message from the transmitter as metadata. The message server may create a so-called timestamp of the reception time of the encrypted message and stores it together with the message in the FIFO queue. Further metadata arising in connection with the reception of the encrypted message by the message server, e.g. the IP address of the transmitter, HTTP headers used and a timing, may be immediately discarded by the message server.

Arrangements to encrypt the message, i.e. to agree on an encryption method to be used and on correspondingly required encryption parameters, may be made by the at least one transmitter and the at least one receiver. The transmitter and the receiver may negotiate details about the encryption via an external server, i.e. outside the secure and anonymous exchange of messages through the computer system (out-of-band), in particular outside the message server. Here, the transmitter and the receiver may agree on any known and appropriate, symmetrical encryption method, such as Advanced Encryption Standard (AES), Data Encryption Standard (DES), Triple-DES, International Data Encryption Algorithm (IDEA), or any known and appropriate, asymmetrical encryption method, such as Rivest, Shamir, and Adleman (RSA). This has the advantage that the message server does not have knowledge of the encryption details of the encrypted message, but is only able to store the encrypted message. Therefore, neither the message server nor a third party can draw conclusions on encryption details of the encrypted message.

The data of the at least one transmitter and the at least one receiver may be encrypted together with the at least one encrypted message.

Thus, the data of the at least one transmitter and the at least one receiver, together with the at least one encrypted message, is completely unstructured. This has the advantage that the data of the transmitter and the receiver can only be reconstructed knowing the encryption parameters. The transmitter encrypts the message and the data of the transmitter and the receiver before sending the thus-encrypted message to the message server.

Optionally, transmitter and receiver may agree on which data of the transmitter and the receiver is to be encrypted together with the message via the external server, together with the agreement on the encryption details. Alternatively, the transmitter may inform the receiver out-of-band about which data of the transmitter and the receiver has been encrypted together with the message after the encrypted message has been sent.

Communication may take place via the Hypertext Transfer Protocol (HTTP) or the Hypertext Transfer Protocol Secure (HTTPS) protocol, wherein Internet Assigned Numbers Authority (IANA) port numbers can be used by default. The only non-encrypted data in the encrypted message is therefore data or metadata of the HTTP communication itself. Optionally, the HTTP communication may be secured via Transport Layer Security (TLS) encryption (HTTPS). Communication via HTTP or HTTPS using standard ports (IANA) has the advantage that any restrictions such as blocked Simple Mail Transfer Protocol (SMTP) ports can be bypassed.

In addition, it can be ensured that the exchange of at least one encrypted message between at least one transmitter, at least one message server, and at least one receiver can take place via arbitrary proxies and proxy cascades to additionally support data protection and data security of the at least one encrypted message, and to ensure the anonymity of the communication parties.

By means of the system, encrypted messages can be exchanged securely and anonymously over the network, without being distinguishable from ordinary messages exchanged over a network from outside. Only by a Deep Packet Inspection (DPI), in which both the metadata in the header of a data packet and the user data is checked for specific features, e.g. protocol violations and computer viruses, is it possible to determine that it is not ordinary messages. But even DPI does not allow analyses of the communication parties and the contents of the encrypted messages.

The at least one receiver of the at least one encrypted message may retrieve, from the message server agreed on with the transmitter, all encrypted messages residing on the message server at the time of retrieval. The methods as explained further below with reference to the Representational State Transfer (REST) methods are available to the at least one receiver. However, other suitable methods of retrieving the messages from the message server are conceivable as well.

For each encrypted message, the message server may use only a time of reception of the encrypted message, i.e. a so-called time stamp, on the message server as metadata. The time stamp may be stored in the FIFO queue together with the message.

This has the advantage that the message server can use the reception time stamp as a key for retrieval of new messages by the at least one receiver. In this way, the at least one receiver is able to retrieve only those encrypted messages from the message server that have been received on the message server after a time of last retrieval of encrypted messages (“If-Modified-Since-Retrieval”, as explained further below with respect to the Representational State Transfer (REST) methods).

Only by decrypting the thus retrieved, encrypted messages can the receiver determine whether they can successfully decrypt one of the messages received and thus is the actual receiver of one or more of the retrieved, encrypted messages. Hence, this is a so-called subscribe-to-broadcast by polling procedure.

This has the advantage that it is only possible to tell from outside that someone is sending or receiving messages through the computer system, however, it is not possible to draw conclusions on the individual communication partners, i.e. the at least one transmitter and the at least one receiver. Thus, anonymity of the at least one transmitter and of the at least one receiver in the exchange of messages is ensured.

The system explained with reference to FIG. 1 allows at least one transmitter and at least one receiver to conduct an asynchronous message exchange in a network in an anonymous and secure way.

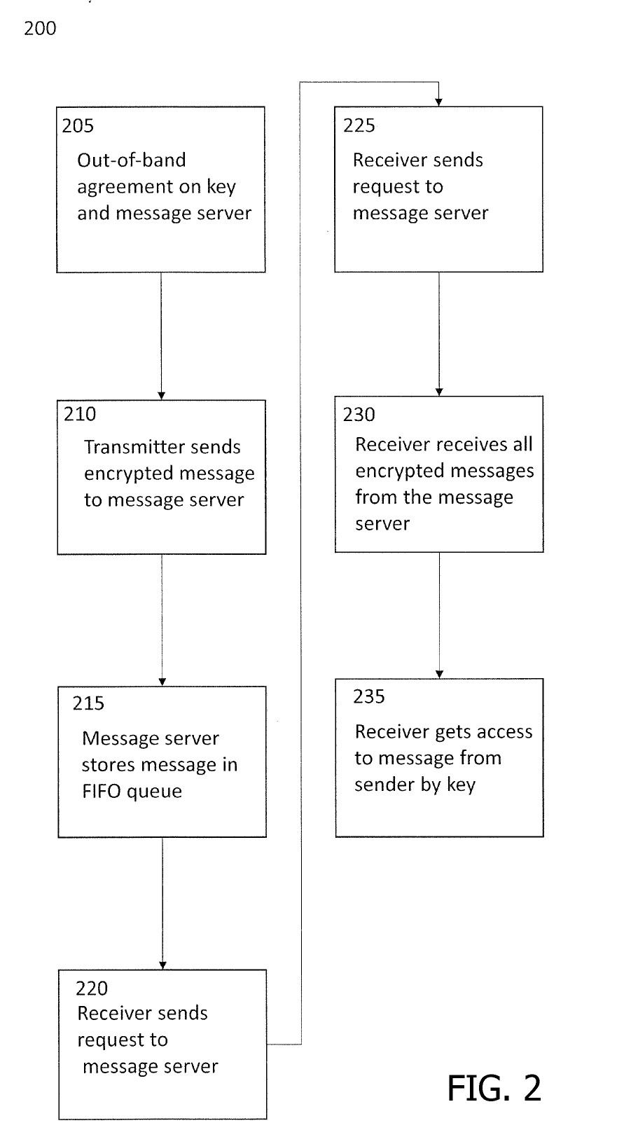

FIG. 2 shows a method for the secure exchange of messages through a computer system as described with reference to FIG. 1.

In step 205, at least one transmitter and at least one receiver, who encrypted messages anonymously and securely over the computer system as described with reference to FIG. 1, agree on an encryption method out-of-band, i.e. outside the main form of communication over at least one message server.

Here, transmitter and receiver may agree on any known and appropriate, symmetrical encryption method, such as Advanced Encryption Standard (AES), Data Encryption Standard (DES), Triple-DES, International Data Encryption Algorithm (IDEA), or asymmetrical encryption methods, such as Rivest, Shamir, and Adleman (RSA).

Moreover, the at least one transmitter and at least one receiver agree out-of-band on an address of the at least one message server residing on the computer system, via which the message exchange is to take place. Each message server can be addressed via an ID (as explained further below with respect to the addressing of the message servers).

Optionally, the transmitter can send the encrypted message to an arbitrary message server without the transmitter and the receiver agreeing on an address of the message server in advance. In this case, the transmitter communicates the ID of the message server, to which the message has been send, out-of-band to the receiver.

In step 210, the at least one transmitter encrypts at least one message with a key according to the encryption method agreed on in step 205. The at least one transmitter sends the thus-encrypted message to the at least one message server agree on with the receiver in step 205. Here, the transmitter can address the message server via an ID (as explained further below with respect to the addressing of the message servers).

Data of the transmitter and the receiver is encrypted together with the message. The encryption of data on the transmitter and the receiver has the advantage that the message can be sent securely and anonymously over existing protocols. In particular, neither the message server nor a third party has the opportunity to obtain information about the transmitter and the receiver of the message, so that anonymity of the communication parties is ensured.

The communication, i.e. sending the encrypted message to the message server and retrieving the message from the message server by the receiver, takes place via the Hypertext Transfer Protocol (HTTP) or the Hypertext Transfer Protocol Secure (HTTPS) protocol, wherein Internet Assigned Numbers Authority (IANA) port numbers can be used by default. The only non-encrypted data in the encrypted message is therefore data or metadata of the HTTP communication itself. Optionally, the HTTP communication may be secured via Transport Layer Security (TLS) encryption (HTTPS). Communication via HTTP or HTTPS using standard ports (IANA) has the advantage that any restrictions such as blocked Simple Mail Transfer Protocol (SMTP) ports can be bypassed.

The transmitter can send the message to the message server by means of methods explained further below with reference to the supported Representational State Transfer (REST) methods.

In addition, it can be ensured that the message exchange between transmitter, message server, and receiver takes place via arbitrary proxies and proxy cascades. In this way, data protection and data security of the encrypted message and anonymity of transmitter and receiver are supported in addition.

In step 215, the addressed message server stores the encrypted message received by the receiver in a FIFO queue or a message buffer. The encrypted messages are at least temporarily stored or buffered there. The FIFO queue may be limited in its length and its storage capacity.

The encrypted message coming in on the message server may additionally be provided with a time stamp stating the arrival time of the message on the message server. The message server uses the time stamp as metadata and stores it in the FIFO queue together with the incoming encrypted message.

The message server can use this metadata as a key for retrieval of new messages. In this way, the at least one receiver is able to retrieve only those encrypted messages from the message server agreed on in step that have been received on the message server after a time of last retrieval (“If-Modified-Since-Retrieval”, as explained further below with respect to the Representational State Transfer (REST) methods).

The buffered, encrypted message cannot be modified or deleted neither by the transmitter and the receiver nor by a third party.

In step 220, the at least one receiver sends a request to the message server agreed on with the transmitter previously as to whether encrypted messages have been received there. The receiver of a message can retrieve all encrypted messages from the message server, agreed on with the transmitter, that are stored on the message server at the time of retrieval. The methods as explained further below with reference to the Representational State Transfer (REST) methods are available to the receiver. However, other suitable methods of retrieving the messages from the message server are conceivable as well. Alternatively, a receiver may only retrieve those encrypted messages from the message server that have been received newly on the message server since a last retrieval (“If-Modified-Since-Retrieval”, as explained further below with respect to the Representational State Transfer (REST) methods).

In step 230, the receiver receives all encrypted messages residing on the message server negotiated with the transmitter in advance (normal retrieval) or all encrypted messages received on the message server after a time of a last request (“If-Modified-Since-Retrieval”).

In step 235, the at least one receiver can decrypt at least one of the retrieved messages with a key according to the encryption method negotiated in step 205.

As the encrypted messages on the message server include only encrypted data of a transmitter and at least one receiver of the encrypted messages, it is at first not possible for the receiver to select the message intended for him from the messages residing on the message server. Therefore, the receiver retrieves all encrypted messages residing on the message server (normal retrieval) or received on the message server after a time of a last request (“If-Modified-Since-Retrieval”). Only by the actual decryption can the receiver determine that he is the actual receiver of the message. Hence, this is a so-called subscribe-to-broadcast by polling procedure.

This approach has the advantage that it is only possible for any third party to tell that messages are exchanged through the system, however, it is not possible to draw conclusions on the individual communication partners, i.e. transmitter and receiver. Thus, anonymity of transmitter and receiver in the exchange of messages is ensured.

### Addressing of the Message Servers

Message servers, as explained above with reference to FIGS. 1 and 2, may be identified with a bit value of a predetermined or predeterminable length as ID. Coding of the ID is performed according to the scheme “URL friendly Base64” as defined in the RFC standard RFC 45648 “Base 64 Encoding with URL and Filename Safe Alphabet”. This is a method for encoding 8-bit binary data in a string that consists only of readable, independent ASCII characters. It allows for an easy transport of arbitrary binary data.

Each ID of each message server may include a 256 bit or 32 byte secure random value. A secure random value is a value that is determined by a software-based random number generator randomly, i.e. the same probabilities for all values. This has the advantage that it is not possible to narrow down the value or to guess it in advance. This random value corresponds to 43 ASCII bytes. To map the bytes as a character chain, 6-to-8 encoding can be performed with Base 64, a method for encoding 8-bit binary data. 6-to-8 encoding means that 6 bits are each represented with one byte per character. Thus, 3 bytes are represented with a chain of 4 letters per character and a chain of 43 characters (43 ASCII bytes) results. This has the advantage that the security of encrypted messages stored on a plurality of message servers is increased in addition. In particular, the IDs or addresses of the message servers are not consecutive, so that it is not possible for a third party to retrieve messages from multiple message servers by trial and error or to guess with significant probability an address of a message server if an address of another message server is known.

N message servers may reside on a server. The server itself includes all possible, possibly non-manifested message server IDs. This has the advantage that the server must not store unused message servers. The server provides merely the possibility to provide additional storage space when needed. Such unused message servers are therefore not (yet) existent, so that the storage space available to the server is not (yet) reserved or used. The server may make available N storage areas. As soon as a message server is addressed to store encrypted messages, this message server is assigned a storage area by means of a hash function. Thus the number of possible message servers when a 256-bit message server ID is used is about 1×10⁷⁷.

Each message server may store the encrypted messages addressed to it in a first in first out (FIFO) queue according to an arrival date of the message. Messages are managed separately for the respective message servers.

Each ID or each Uniform Resource Locator (URL) of each message server may be composed of the following components:
A protocol used, e.g. HTTPS or HTTP;
A server address used, e.g. IPv4 or IPv6 address, wherein in case a port not standardized by the IANA is used, the port number is attached;
A service path representing the base path of the server, e.g. a URL of a Hypertext Preprocessor (PHP)—scripts or a mapping in the reverse proxy. The service path includes the leading slash (“/”);
Identification of the message server.

An ID or URI or URL of every message server is only valid if it closes with the ID of the message server.

The above requirements of a valid ID or URI or URL of a message server can be represented in the Backus-Naur form in accordance with the World Wide Web Consortium (W3C) as follows:

url ::= protocol “://” serviceaddress servicepath “/”

nachrichtenserverid

protocol ::= “https” | “http”
serveraddress ::= IPv4 | IPv6 | DNSName
serverport ::= “1” − “65535”
serviceaddress ::= serveraddress ( “:” serverport ) ?
servicepath ::= “/” [ URLChars, “/” ] *
friendlybase64char ::= [ “A” − “Z”, “a” − “z”, “0” − “9”, “—”, “_” ]
nachrichtenserverid ::= <43>*friendlybase64char

For example, a valid ID of a message server could be as follows:

http://d.example:1234/tools/nachrichtenserver/xzjall . . . aatr42

Representational State Transfer (REST) methods

The following REST methods may be available for an anonymous and secure message exchange as explained above with reference to FIGS. 1 and 2:

GET: Using the GET method or HEAD request, a receiver can retrieve all messages residing on a message server.

If a receiver sends a request to a message server using a GET method, the following return values are possible:
An error message HTTP 400 if the message server ID in the URL is missing or is not valid;
A not-found error message HTTP 404 if the message server does not contain encrypted messages;
An OK message HTTP 200 if the message server contains encrypted messages. Accordingly, the message server sends an HTTP response to the GET method, with which all messages residing on the message server are sent to the receiver.

Alternatively, a receiver may retrieve all messages that have been received newly on the message server since a last date of retrieval (“If-Modified-Since-Retrieval”). The message server stores the encrypted messages in a FIFO queue and provides a so-called time stamp of the reception time to each message. If the receiver sends a request with an “If-Modified-Since” header, i.e. with a header in the form of “If-Modified-Since:DATE”, the receiver receives only the messages received on the message server since DATE.

In this case, if a receiver sends a request to a message server using a GET method, the following return values are possible:
An error message HTTP 400 if the message server ID in the URL is missing or is not valid;
A not-found error message HTTP 404 if the message server does not contain encrypted messages;
A not-modified error message 304 if the message server does not contain encrypted messages added after a last “If-Modified-Since”-request;
An OK message HTTP 200 if the message server contains encrypted messages added after a last “If-Modified-Since”-request. Accordingly, the message server sends an HTTP response to the GET method, with which all new encrypted messages are sent to the receiver.

Optionally, an HTTP body can be returned as a Multipurpose Internet Mail Extensions (MIME) multipart message of each individual message. Here, each MIME multipart message has the following characteristics:
The “content-type” is “multipart/mixed”;
Each individual part has a “content-type” of “application/octetstream” and a “date” header;
The messages are uncoded 8 bit streams.

In standardized requests (e.g. HTTP-GET), a complete document, which is composed of different parts, i.e. the individual messages, is returned in response to the request. In the MIME multipart method, however, these parts, i.e. the individual messages, are separated according to the MIME multipart method.

HEAD: Using the HEAD method or HEAD request, a receiver can determine whether a message server is filled or if a new message has arrived. Each HEAD method requests metadata on encrypted messages from the message server.

If a receiver sends a request to a message server using a HEAD method, the following return values are possible:
An error message HTTP 400 if the message server ID in the URL is missing or is not valid;
A not-found error message HTTP 404 if the message server does not contain encrypted messages;
An OK message HTTP 200 if the message server contains encrypted messages.

Alternatively, a receiver may request by means of a HEAD method whether new encrypted messages have been received on the message server since a last date of retrieval (“If-Modified-Since-Retrieval”). In this case, the following return values are possible:
An error message HTTP 400 if the message server ID in the URL is missing or is not valid;
A not-found error message HTTP 404 if the message server does not contain encrypted messages;
A not-modified error message 304 if the message server does not contain encrypted messages added after a last “If-Modified-Since”-request;
An OK message HTTP 200 if the message server contains encrypted messages added after a last “If-Modified-Since”-request.

In each HEAD method or HEAD request, an HTTP body is not returned.

POST: Using a POST method or POST request, a transmitter can send an encrypted message to a message server. It is irrelevant whether one or more encrypted messages are already residing on the message server or whether there is no encrypted message on the message server. The following return values are supported for POST methods:
An error message HTTP 400 if the message Server ID in the URL is missing or is not valid;
An OK message HTTP 200 if the encrypted message of the transmitter has successfully arrived on the message server. In this case, the encrypted message is stored on the message server at least temporarily. The encrypted message must be delivered to the message server as HTTP body, the HTTP body being an uncoded 8-bit stream. No HTTP body is returned by the message server.

This clear limit of the scope of possible methods or operations for the secure and anonymous transmission of messages over a network, as explained above, allows an easy setup of a message server or a server on which one or more message servers are implemented. Thus, a simple possibility to set up a message server and securely operate it is provided, so that any transmitter and any receiver can anonymously and securely exchange encrypted messages over a message server, as explained above with reference to FIGS. 1 and 2. Since there is no user identification, no user administration is required. The use of cookies is superfluous as well. Thus, the system can be made openly and publicly accessible to any user, without losing security and anonymity of the communication parties.

A complete obfuscation of communication taking place at all is hardly possible, as necessary IP connections are visible in principle. However, an additional concealment of the fact that a network communication takes place in the system as explained above with reference to FIGS. 1 and 2 at all, can be achieved by the use of additional layers, such as The Onion Routing (Tor).

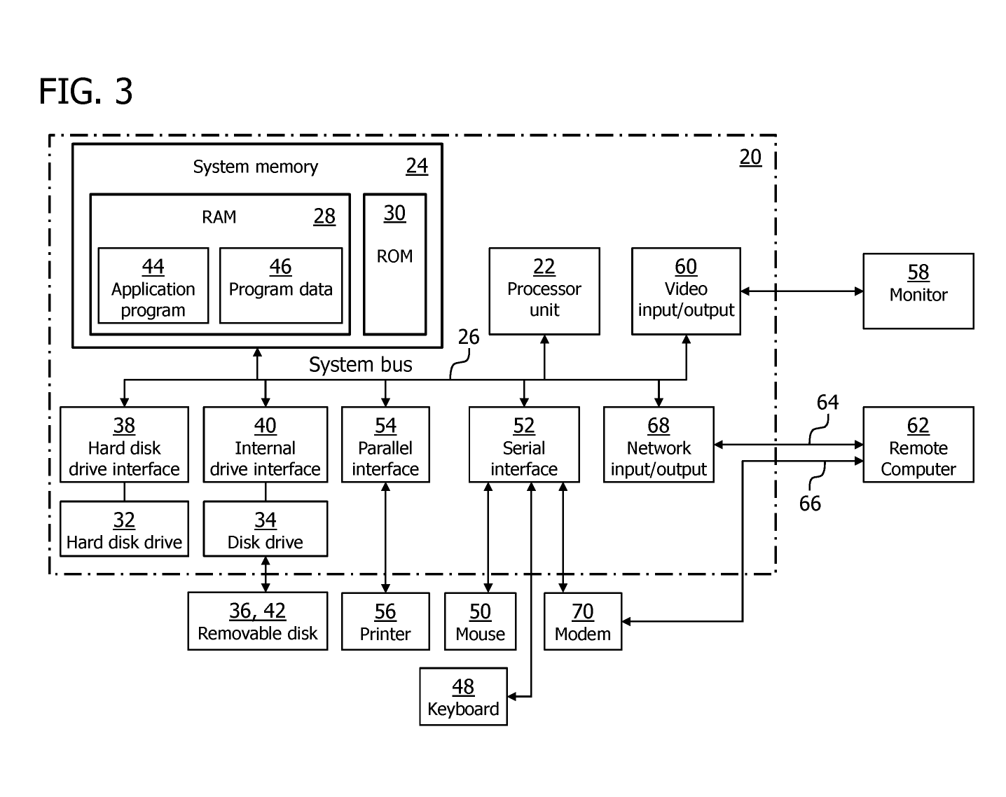

An exemplary system for implementing the embodiments of the disclosure is described with reference to FIG. 3. An exemplary system includes a universal computer device in the form of a conventional computing environment 20, e.g. a personal computer (PC) 20, with a processor unit 22, a system memory 24, and a system bus 26, which combines a plurality of system components, among others the system memory 24 and the processor unit 22. The processor unit 22 can perform arithmetic, logical and/or control operations by accessing the system memory 24. The system memory 24 can store information and/or instructions to be used in combination with the processor unit 22. The system memory 24 can include volatile and non-volatile memories, for example Random-Access Memory (RAM) 28 and Read-Only Memory (ROM) 30. A Basic Input/Output System (BIOS), which contains the basic routines that help to transfer information between the elements within the PC 20, for example during start-up, can be stored in the ROM 30. The system bus 26 may be one of many bus structures, among others a memory bus or a memory controller, a peripheral bus, and a local bus, which uses a specific bus architecture from a plurality of bus architectures.

Moreover, the PC 20 may include a hard disk drive 32 for reading or writing to a hard disk (not shown), and an external disk drive 34 for reading or writing to a removable disk 36 or a removable date carrier. The removable disk may be a magnetic disk for a magnetic disk drive, or an optical disk, e.g. a CD-ROM, for an optical disk drive. The hard disk drive 32 and the external disk drive 34 are connected to the system bus 26 via a hard disk drive interface 38 and an external disk drive interface 40, respectively. The drives and the associated computer-readable media provide a non-volatile memory of computer-readable instructions, data structures, program modules, and other data for the PC 20. The data structures may have the relevant data for implementing a method as described above. Although the exemplarily described environment uses a hard disk (not shown) and an external disk 42, is obvious to the skilled person that other types of computer-readable media, which can store computer-accessible data, can be used in the exemplary work environment, e.g. magnetic tapes, flash memory cards, digital video disks, Random-Access Memory, Read-Only Memory, etc.

A plurality of program modules, in particular an operating system (not shown), one or more application programs 44, or program modules (not shown), and program data 46, can be stored on the hard drive, the external disk 42, the ROM 30 or the RAM 28. The application programs may include at least some of the functionality, as shown in FIG. 1 or FIG. 2.

A user can enter commands and information, as described above, into the PC 20 by means of input devices, such as a keyboard 48 and a computer mouse 50. Other input devices (not shown) may include a microphone and/other sensors, a joystick, a game pad, a scanner or the like. These or other input devices can be connected to the processor unit 22 by means of a serial interface 52 coupled to the system 26, or may be connected by means other interfaces, such as a parallel interface 54, a game port or a universal serial bus (USB). Moreover, information can be printed with a printer 56. The 56 printer and other parallel input/output devices can be connected to the processor unit 22 by means of the parallel interface 54. A monitor 58 or other types of display device(s) 26 is/are connected to the system bus 26 by means of an interface, such as a video input/output 60. In addition to the monitor, the computing environment 20 may include other peripheral output devices (not shown), such as loudspeakers or acoustic outputs.

The computing environment 20 can communicate with other electronic devices, such as a computer, a corded phone, a cordless phone, a personal digital assistant (PDA), a TV or the like. To communicate, the computing environment 20 may operate in a networked environment, where connections to one or more electronic devices are used. FIG. 3 shows the computing environment networked with a remote computer 62. The remote computer 62 may be a different computing environment, such as a server, a router, a network PC, a peer device or other conventional network nodes, and may include many or all of the elements described above with respect to the computing environment 20. The logical connections, as shown in FIG. 3, include a local area network (LAN) 64 and a wide area network (WAN) 66. Such network environments are commonplace in offices, company-wide computer networks, intranets and the Internet.

If a computing environment 20 is used in a LAN network environment, the computing environment 20 may be connected to the LAN 64 by a network input/output 68. If the computing environment 20 is used in a WAN environment, the computing environment 20 may include a modem 70 or other means for establishing a communication over the WAN 66. The modem 70, which may be internal or external with respect to the computing environment 20, is connected to the system bus 26 by means of the serial interface 52. In the network environment, program modules shown relative to the computing environment 20 or portions thereof may be stored in a remote storage device, which are accessible or system-inherent on or by a remote computer 62. Further, other data that is relevant to the above-described method or system may be accessible on or by the remote computer 62.

1. A computer system for a secure and anonymous exchange of messages over a network, comprising:
at least one message server adapted to:
receive at least one encrypted message from at least one transmitter over the network and to store the at least one encrypted message at least temporarily; and
provide the at least one encrypted message to at least one receiver for retrieval over the network, wherein data of the at least one transmitter and of the at least one receiver of the at least one encrypted message is encrypted.

2. The computer system according to claim 1, wherein the data of the at least one transmitter and of the at least one receiver of the at least one encrypted message comprises at least one of the following data:
a transmitter address of the at least one transmitter;
a receiver address of the at least one receiver;
an encryption method used to encrypt the at least one encrypted message; and
encryption parameters used to encrypt the at least one encrypted message.

3. The computer system according to claim 1, wherein the data of the at least one transmitter and of the at least one receiver is encrypted together with the at least one encrypted message.

4. The computer system according to claim 1, wherein the at least one transmitter and the at least one receiver agree on an address of the at least one message server at a time prior to reception of the at least one message by the at least one message server.

5. The computer system according to claim 1, wherein the at least one message server stores a reception time stamp of the encrypted message on the at least one message server when the at least one encrypted message is received and stored, and wherein the at least one message server deletes the received message after a predetermined or predeterminable period of time as of the reception time stamp.

6. A computer-implemented method for a secure and anonymous exchange of messages over a network, comprising:
receiving, by the at least one message server, at least one encrypted message from at least one transmitter over the network, said at least one message server adapted to store the received at least one encrypted message at least temporarily; and
providing, by the at least one message server, the at least one encrypted message for retrieval by at least one receiver over the network, wherein data of the at least one transmitter and of the at least one receiver of the at least one encrypted message is encrypted.

7. The computer-implemented method according to claim 6, wherein the data of the at least one transmitter and of the at least one receiver of the at least one encrypted message comprises at least one of the following data:
a transmitter address of the at least one transmitter; and
a receiver address of the at least one receiver, wherein the data of the at least one transmitter and of the at least one receiver is encrypted together with the at least one encrypted message.

8. The computer-implemented method according to claim 6, wherein the at least one transmitter and the at least one receiver agree on an address of the at least one message server at a time prior to reception of the at least one message by the at least one message server.

9. The computer-implemented method according to claim 6, wherein the at least one message server stores a reception time stamp of the encrypted message on the at least one message server when the at least one encrypted message is received and stored, and wherein the at least one message server deletes the received message after a predetermined or predeterminable period of time as of the reception time stamp.

10. A computer program product comprising program parts, which, when loaded in a computer, are adapted to perform a computer-implemented method according to claim 6.
